(19) United States
(12) Patent Application Publication
(10) Pub. No.: US 2025/0300400 A1
(43) Pub. Date: Sep. 25, 2025

(54) Connector Housing Assembly, Connector and Connector Assembly

(71) Applicants: Tyco Electronics (Shanghai) Co., Ltd., Shanghai (CN); Tyco Electronics Technology (SIP) Co., Ltd., Suzhou (CN)

(72) Inventors: Tomo Hu, Suzhou (CN); Lei Li, Suzhou (CN); Hai Wang, Suzhou (CN); Jianxiong (Jesse) Li, Shanghai (CN); Reicky Zhang, Shanghai (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/083,750

(22) Filed: Mar. 19, 2025

(30) Foreign Application Priority Data
Mar. 19, 2024 (CN) 202420530071.1

(51) Int. Cl. H01R 13/629

(52) U.S. Cl. CPC H01R 13/62933

(57) ABSTRACT

A connector housing assembly includes a housing and a locking lever. The housing has two opposite sides in a transverse direction. The locking lever is rotatably mounted on the housing and rotates around an axis parallel to the transverse direction between a pre lock position and a final lock position. The locking lever has a pair of force arms and a connecting arm connected between an upper end of each force arm. Each force arm has a lower end rotatably connected to one side of the housing. Support surfaces perpendicular to a height direction of the housing are formed on both sides of the housing. Elastic cantilevers each having a flat pre lock surface are each formed on one lower end. When the locking lever is in the pre lock position each support surface contacts one flat pre lock surface keeping the locking lever in the pre lock position.

### CROSS-REFERENCE TO RELATED APPLICATION

This application claims the benefit of the filing date under 35 U.S.C. § 119 (a)-(d) of Chinese Patent Application No. CN202420530071.1 filed on Mar. 19, 2024.

### FIELD OF THE INVENTION

The present invention relates to a connector housing assembly and, more particularly, to a connector housing assembly, a connector comprising the connector housing assembly and a connector assembly comprising the connector.

### BACKGROUND OF THE INVENTION

In the prior art, a connector typically includes a housing, a terminal provided in the housing, and a locking lever rotatably mounted on the housing. The locking lever can be rotated between a pre lock position and a final lock position. The locking lever is used to drive a mating housing of a mating connector to move from a pre installation position to a final installation position. When the locking lever is rotated from the pre lock position to the final lock position, the locking lever can drive the mating housing to move from the pre installation position to the final installation position. In the prior art, to keep the locking lever in the pre lock position, two types of retaining structures need to be set on the housing and the locking lever. One retaining structure prevents the locking lever from being rotated forward from the pre lock position, and the other retaining structure prevents the locking lever from being rotated backward from the pre lock position. This leads to a complex structure of the locking lever and housing.

### SUMMARY OF THE INVENTION

A connector housing assembly includes a housing and a locking lever. The housing has two opposite sides in a transverse direction of the housing. The locking lever is rotatably mounted on the housing and rotates around an axis parallel to the transverse direction between a pre lock position and a final lock position. The locking lever has a pair of force arms and a connecting arm connected between an upper end of each force arm. Each force arm has a lower end rotatably connected to one side of the housing. Support surfaces perpendicular to a height direction of the housing are formed on both sides of the housing. Elastic cantilevers each having a flat pre lock surface are each formed on one lower end. When the locking lever is in the pre lock position each support surface contacts one flat pre lock surface keeping the locking lever in the pre lock position.

### BRIEF DESCRIPTION OF DRAWINGS

The invention will now be described by way of example with reference to the accompanying figures, of which:

FIG. 1 is a perspective view of a connector according to an exemplary embodiment;

FIG. 2 is a perspective exploded view of the connector of FIG. 1;

FIG. 3 is a front side perspective view of a locking lever of the connector of FIG. 1;

FIG. 4 is a rear side perspective view of the locking lever of FIG. 3;

FIG. 5 is a front side perspective view of the connector of FIG. 1;

FIG. 6 is a front side exploded view of the connector of FIG. 1;

FIG. 7 is a cross-sectional view of the connector of FIG. 1;

FIG. 8 is a plan view of the connector of FIG. 1;

FIG. 9 is a perspective view of a separated position between a mating connector according to an exemplary embodiment and the connector of FIG. 1;

FIG. 10 is a perspective view of the connector of FIG. 1 and the mating connector of FIG. 9 in a pre installation position; and

FIG. 11 is a perspective view of the connector of FIG. 1 and the mating connector of FIG. 9 in a final installation position.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

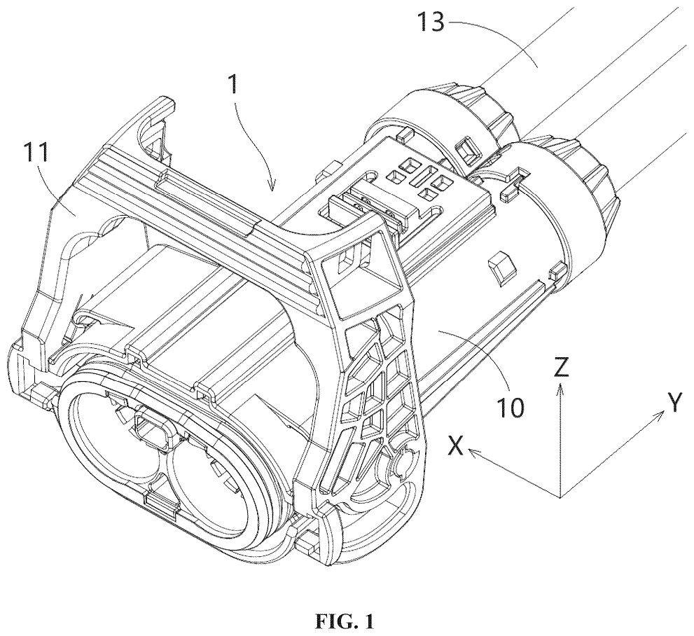

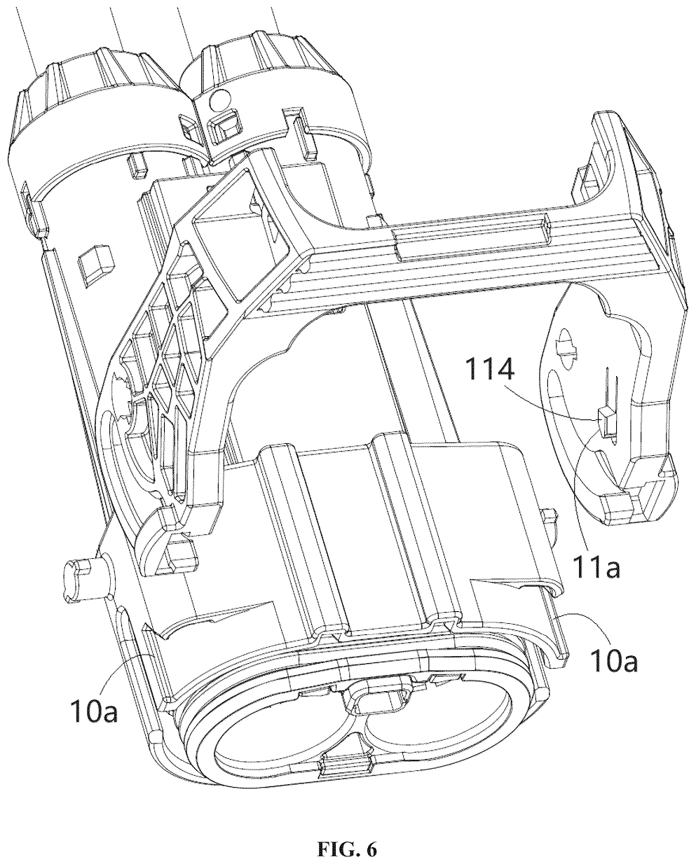

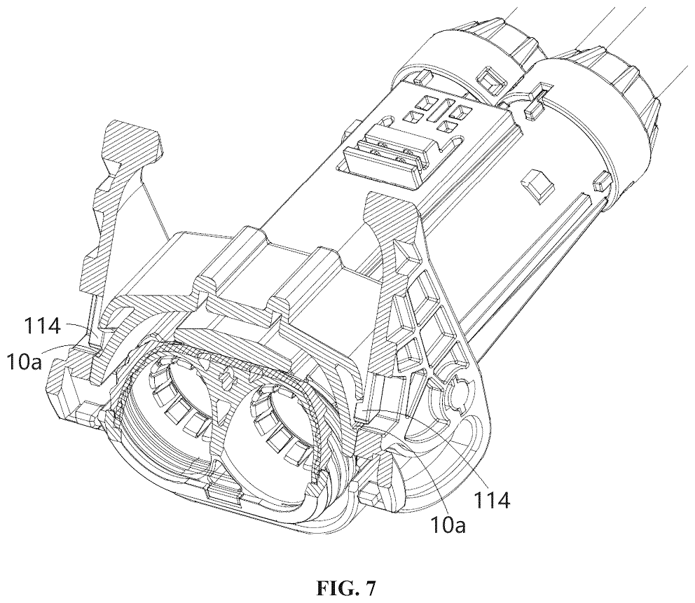

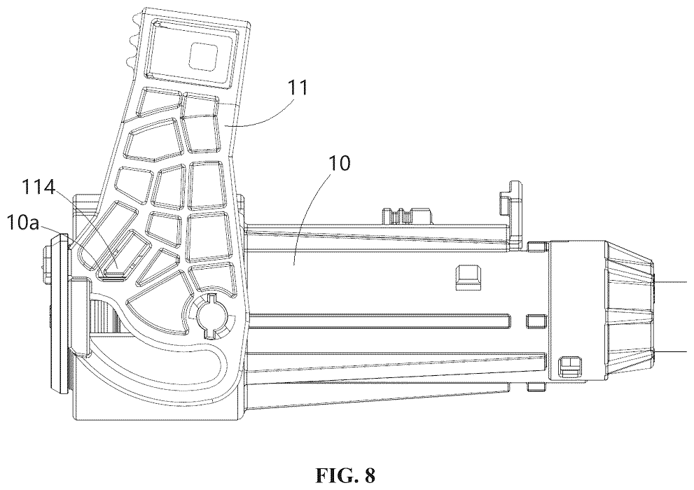

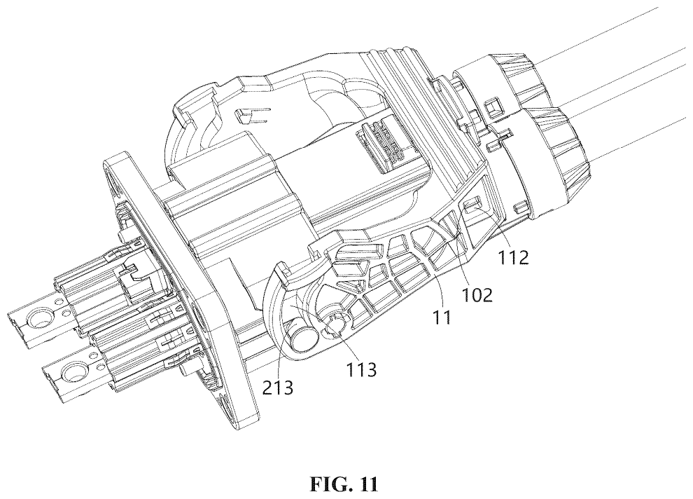

An exemplary embodiment of a connector housing assembly is now described with reference to FIGS. 1-11. As shown in FIGS. 1 and 8, the connector housing assembly comprises a housing 10 and a locking lever 11. The housing 10 has two opposite sides in its transverse direction X, as shown in FIGS. 1-2 and 5-6. The locking lever 11 is rotatably installed on the housing 10, suitable for rotating around an axis parallel to the transverse direction X between a pre lock position (position shown in FIG. 1) and a final lock position (position shown in FIG. 11).

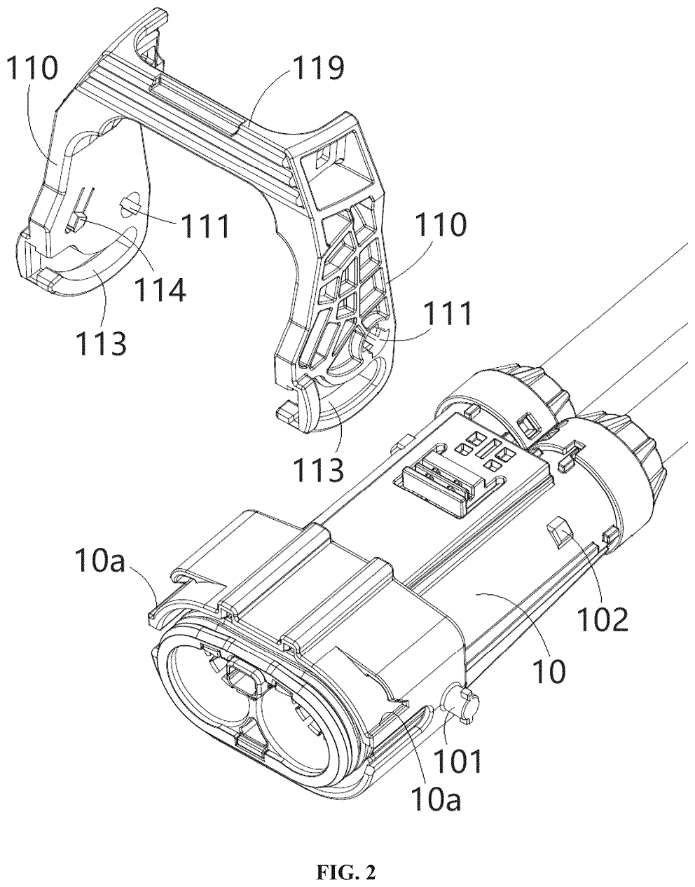

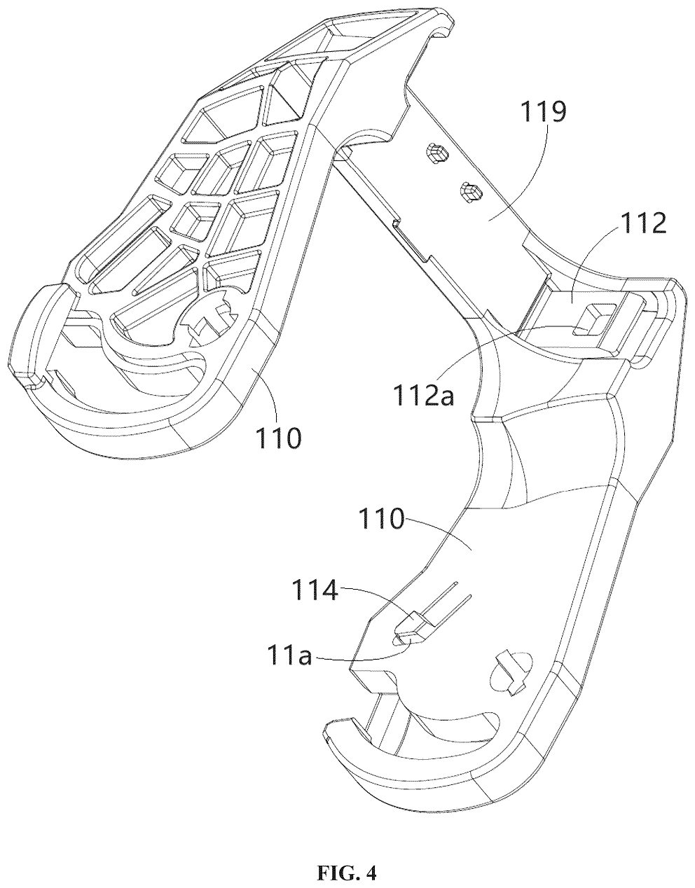

As shown in FIGS. 2-4, the locking lever 11 includes a pair of force arms 110 and a connecting arm 119. The lower ends of the pair of force arms 110 are rotatably connected to both sides of the housing 10, respectively. The connecting arm 119 is connected between the upper ends of a pair of force arms 110. As shown in FIGS. 2 and 5-8, support surfaces 10a perpendicular to the height direction Z of the housing 10 are respectively formed on both sides of the housing 10. Elastic cantilevers 114 with flat pre lock surfaces 11a are respectively formed on the lower ends of the pair of force arms 110, as shown in FIG. 4. When the locking lever 11 is in the pre lock position, the support surface 10a of the housing 10 comes into contact with the flat pre lock surface 11a of the elastic cantilever 114 to hold the locking lever 11 in the pre lock position.

As shown in FIG. 1, the housing 10 has front and rear ends that are opposite in its longitudinal direction Y. The locking lever 11 is rotatably mounted on the front end of the housing 10. When the locking lever 11 in the pre lock position is pushed forward, the flat pre lock surface 11a of the locking lever 11 is pressed down on the support surface 10a, preventing the locking lever 11 from being rotated forward from the pre lock position. When the locking lever 11 in the pre lock position is pushed backwards, the flat pre lock surface 11a of the locking lever 11 is moved in a direction away from the support surface 10a (i.e. rotates upwards around the rotation axis of the locking lever 11), allowing the locking lever 11 to rotate backwards from the pre lock position to the final lock position.

When the backward pushing force applied to the locking lever 11 in the pre lock position cannot overcome the frictional engagement force between the flat pre lock surface 11a and the support surface 10a, the locking lever 11 will not rotate backward and will be held in the pre lock position. When the backward pushing force applied to the locking lever 11 in the pre lock position can overcome the frictional engagement force between the flat pre lock surface 11a and the support surface 10a, the locking lever 11 will rotate backward from the pre lock position to the final lock position.

The lower end of the force arm 110, as shown in FIGS. 2-5, is plate-shaped, with an inner side facing the housing 10 and an outer side facing away from the housing 10. As shown in FIG. 4, the end of the elastic cantilever 114 protrudes from the inner surface of the lower end of the force arm 110, and the flat pre lock surface 11a is formed on the end of the elastic cantilever 114.

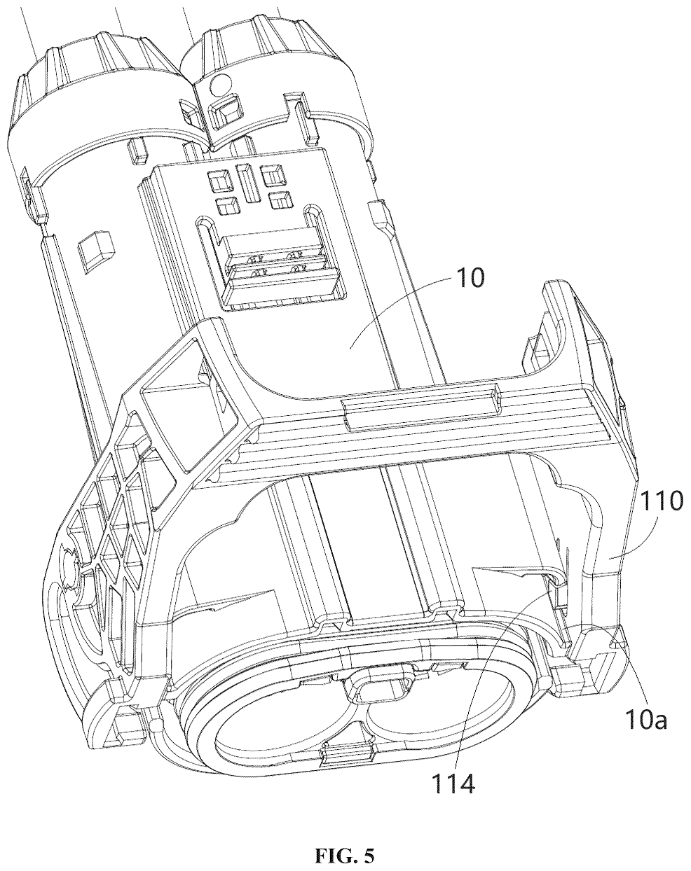

As shown in FIG. 5, an opening 115 is formed in the lower end of the force arm 110, and the elastic cantilever 114 is suspended in the opening 115 and connected to the upper side edge of the opening 115. When the locking lever 11 is in the pre lock position, the elastic cantilever 114 extends obliquely from its root in downward and forward directions, so that the extension direction of the elastic cantilever 114 is inclined to the support surface 10a of the housing 10.

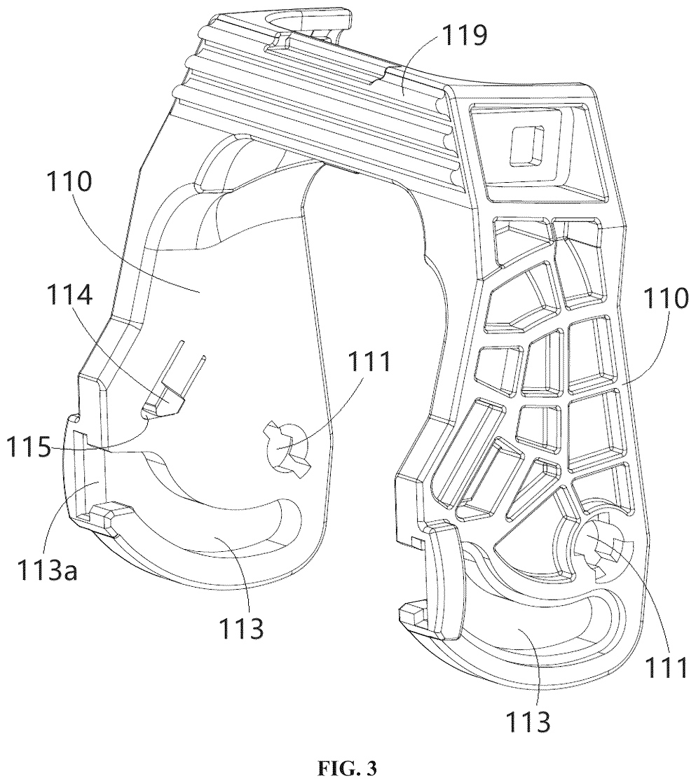

As shown in FIGS. 2-3, a connecting hole 111 is formed in the lower end of the force arm 110, and connecting shafts 101 are respectively formed on both sides of the front end of the housing 10. The connecting shafts 101 are rotatably connected into the connecting hole 111 to rotatably install the locking lever 11 onto the housing 10. When the locking lever 11 is in the pre lock position, the axis of the connecting shaft 101 and the connecting hole 111 is located below and behind the flat pre lock surface 11a of the elastic cantilever 114.

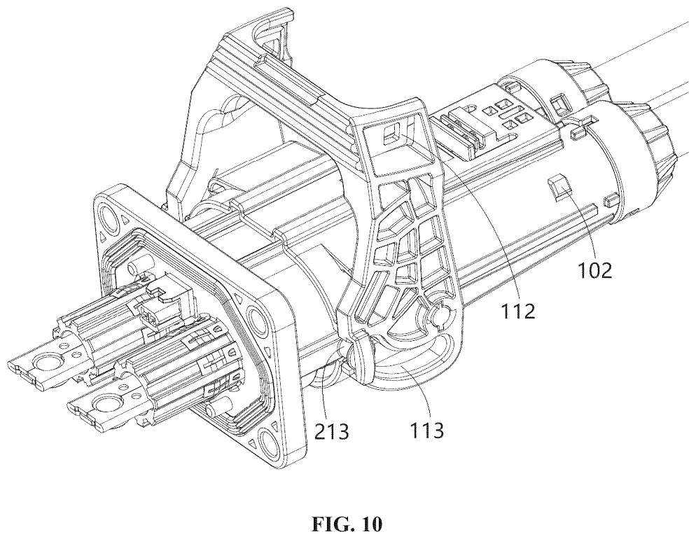

Protrusions 102, as shown in FIGS. 2 and 10-11, are respectively formed on both sides of the rear end of the housing 10, and the locking lever 11 also includes a pair of elastic locking buckles 112, as shown in FIGS. 4 and 10, connected to the connecting arm 119, with a snap slot 112a formed in the elastic locking buckle 112. When the locking lever 11 is rotated to the final lock position, the protrusion 102 on the housing 10 is engaged with the snap slot 112a of the elastic locking buckle 112 to keep the locking lever 11 in the final lock position. The pair of elastic locking buckles 112 are respectively connected to both ends of the connecting arm 119 and located on the inner side of the upper end of the pair of force arms 110.

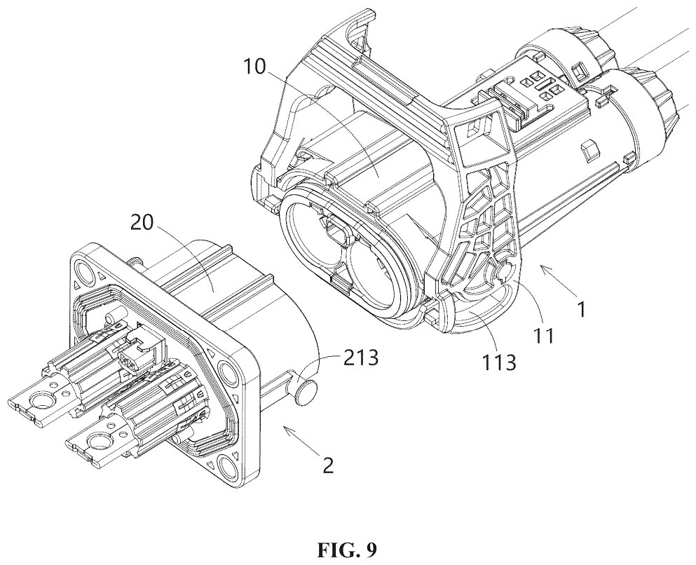

An arc-shaped groove 113, as shown in FIGS. 2-3 and 9-11, is formed in the lower end of the force arm 110. As shown in FIGS. 9-11, the arc-shaped groove 113 is adapted to slidably fit with a protruding post 213 on a mating housing 20 of a mating connector 2, for converting the backward rotation of the locking lever 11 into the backward horizontal movement of the mating housing 20, to drive the mating housing 20 to move along the longitudinal direction Y of the housing 10 from a pre installation position to a final installation position.

As shown in FIG. 3, the arc-shaped groove 113 has an inlet 113a located at one end that allows the protruding post 213 on the mating housing 20 to enter. As shown in FIGS. 10-11, when the mating housing 20 is moved from the pre installation position (position shown in FIG. 10) to the final installation position (position shown in FIG. 11), the protruding post 213 on the mating housing 20 is moved from the inlet 113a at one end of the arc-shaped groove 113 to the closed other end of the arc-shaped groove 113.

An exemplary embodiment of a connector 1 is now described with reference to FIGS. 1-11. The connector 1 includes the aforementioned connector housing assembly and a terminal, the terminal is provided in the housing 10.

As shown in FIG. 1, the connector 1 further comprises a cable 13, one end of which extends into the housing 10 and is electrically connected to the terminal.

An exemplary embodiment of a connector assembly is now described with reference to FIGS. 1-11. As shown in FIG. 9, the connector assembly comprises the connector 1 and the mating connector 2. The mating connector 2 is mated with the connector 1. The mating connector 2 includes the mating housing 20 and a mating terminal. The mating housing 20 is mated with the housing 10 of the connector 1. The mating terminal is set in the mating housing 20 for mating with the terminal of the connector 1.

As shown in FIGS. 9-11, the protruding post 213 is formed on the mating housing 20, which is suitable for slidably fitting with the arc-shaped groove 113 on the locking lever 11 of the connector 1. The mating housing 20 can be moved relative to the housing 10 between the pre installation position and the final installation position. When the locking lever 11 is rotated backwards from the pre lock position to the final lock position, the protruding post 213 on the mating housing 20 is moved from the inlet 113a at one end of the arc-shaped groove 113 to the closed other end of the arc-shaped groove 113, to drive the mating housing 20 from the pre installation position to the final installation position through the arc-shaped groove 113.

In the aforementioned exemplary embodiments according to the present invention, the support surface 10a on the housing 10 and the flat pre lock surface 11a on the locking lever 11 can simultaneously prevent the locking lever 11 from being rotated forward and backward. Therefore, the locking lever 11 and the retaining structure of the housing 10 are simplified.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A connector housing assembly, comprising:
a housing having two opposite sides in a transverse direction of the housing; and
a locking lever rotatably mounted on the housing, the locking lever rotates around an axis parallel to the transverse direction between a pre lock position and a final lock position, the locking lever has a pair of force arms and a connecting arm connected between an upper end of each force arm, each force arm has a lower end rotatably connected to one side of the housing, support surfaces perpendicular to a height direction of the housing are formed on both sides of the housing, elastic cantilevers each having a flat pre lock surface are each formed on one lower end, when the locking lever is in the pre lock position each support surface contacts one flat pre lock surface keeping the locking lever in the pre lock position.

2. The connector housing assembly of claim 1, wherein the housing has a front end and a rear end opposite the front end in a longitudinal direction of the housing, the locking lever is rotatably mounted on the front end, when the locking lever in the pre lock position is pushed forward, each flat pre lock surface of the locking lever is pressed down on one support surface, preventing the locking lever from rotating forward from the pre lock position, when the locking lever in the pre lock position is pushed backwards, each flat pre lock surface of the locking lever moves away from one support surface, allowing the locking lever to rotate backwards from the pre lock position to the final lock position.

3. The connector housing assembly of claim 2, wherein the locking lever will not rotate backward and will be held in the pre lock position when a backward pushing force applied to the locking lever in the pre lock position cannot overcome a frictional engagement force between each flat pre lock surface and one support surface, and the locking lever will rotate backward from the pre lock position to the final lock position when the backward pushing force applied to the locking lever in the pre lock position can overcome the frictional engagement force between each flat pre lock surface and one support surface.

4. The connector housing assembly of claim 1, wherein the lower end of each force arm is plate-shaped, each lower end has an inner side facing the housing and an outer side facing away from the housing, and an end of each elastic cantilever protrudes from an inner surface of each lower end, the flat pre lock surface is formed on the end of each elastic cantilever.

5. The connector housing assembly of claim 4, wherein an opening is formed in the lower end of each force arm, each elastic cantilever is suspended in one opening and connected to an upper side edge of the one opening.

6. The connector housing assembly of claim 1, wherein when the locking lever is in the pre lock position, an extension direction of each elastic cantilever is inclined to one support surface of the housing.

7. The connector housing assembly of claim 6, wherein each elastic cantilever has a root, each elastic cantilever extends obliquely from its root in downward and forward directions.

8. The connector housing assembly of claim 7, wherein a connecting hole is formed in the lower end of each force arm, and a connecting shaft is formed on both sides of a front end of the housing, each connecting shaft is rotatably connected into one connecting hole, each connecting shaft rotatably installs the locking lever onto the housing.

9. The connector housing assembly of claim 8, wherein an axis of each connecting shaft and each connecting hole is located below and behind the flat pre lock surface of each elastic cantilever when the locking lever is in the pre lock position.

10. The connector housing assembly of claim 1, wherein protrusions are formed on both sides of a rear end of the housing, and the locking lever has a pair of elastic locking buckles each connected to one connecting arm, a snap slot is formed on each elastic locking buckle, each protrusion is engaged with one snap slot keeping the locking lever in the final lock position when the locking lever is rotated to the final lock position.

11. The connector housing assembly of claim 10, wherein the pair of elastic locking buckles are respectively connected to both ends of each connecting arm and respectively located on an inner side of the upper end of each force arm.

12. The connector housing assembly of claim 1, wherein an arc-shaped groove is formed in the lower end of each force arm, the arc-shaped groove slidably fits with one protruding post on a mating housing of a mating connector and converts a backward rotation of the locking lever into a backward horizontal movement of the mating housing driving the mating housing to move along a longitudinal direction of the housing from a pre installation position to a final installation position.

13. The connector housing assembly of claim 12, wherein each arc-shaped groove has an inlet located at one end that allows one protruding post on the mating housing to enter, each protruding post on the mating housing is moved from one inlet at one end of one arc-shaped groove to a closed other end of the one arc-shaped groove when the mating housing is moved from the pre installation position to the final installation position.

14. A connector, comprising:
a connector housing assembly including a housing and a locking lever, the housing has two opposite sides in a transverse direction of the housing, and the locking lever is rotatably mounted on the housing, the locking lever rotates around an axis parallel to the transverse direction between a pre lock position and a final lock position, the locking lever has a pair of force arms and a connecting arm connected between an upper end of each force arm, each force arm has a lower end rotatably connected to one side of the housing, support surfaces perpendicular to a height direction of the housing are formed on both sides of the housing, elastic cantilevers each having a flat pre lock surface are each formed on one lower end, when the locking lever is in the pre lock position each support surface contacts one flat pre lock surface keeping the locking lever in the pre lock position; and
a terminal provided in the housing.

15. The connector of claim 14, further comprising a cable, one end of the cable extends into the housing and is electrically connected to the terminal.

16. A connector assembly, comprising:
a connector, including a connector housing assembly and a terminal, the connector housing assembly includes a housing and a locking lever, the housing has two opposite sides in a transverse direction of the housing, and the locking lever is rotatably mounted on the housing, the locking lever rotates around an axis parallel to the transverse direction between a pre lock position and a final lock position, the locking lever has a pair of force arms and a connecting arm connected between an upper end of each force arm, each force arm has a lower end rotatably connected to one side of the housing, support surfaces perpendicular to a height direction of the housing are formed on both sides of the housing, elastic cantilevers each having a flat pre lock surface are each formed on one lower end, when the locking lever is in the pre lock position each support surface contacts one flat pre lock surface keeping the locking lever in the pre lock position, the terminal is provided in the housing; and
a mating connector mated with the connector, the mating connector includes a mating housing mated with the housing of the connector, and a mating terminal provided in the mating housing mating with the terminal of the connector.

17. The connector assembly of claim 16, wherein a protruding post formed on the mating housing slidably fits with an arc-shaped groove on the locking lever, the mating housing moves relative to the housing between a pre installation position and a final installation position, when the locking lever is rotated backwards from the pre lock position to the final lock position, the protruding post on the mating housing moves from an inlet at one end of the arc-shaped groove to a closed other end of the arc-shaped groove driving the mating housing from the pre installation position to the final installation position through the arc-shaped groove.
